(19) United States
(12) Patent Application Publication
(10) Pub. No.: US 2016/0248729 A1
(43) Pub. Date: Aug. 25, 2016

(54) A MOVABLE GATEWAY, A DHCP SERVER AND RESPECTIVE METHODS PERFORMED THEREBY FOR ENABLING THE GATEWAY TO MOVE FROM A FIRST ACCESS POINT TO A SECOND ACCESS POINT

(71) Applicant: TELEFONAKTIEBOLAGET L M ERICSSON(PUBL), Stockholm (SE)

(72) Inventors: Baifeng CUI, Beijing (CN); Jiang HE, Beijing (CN); Ying LU, Beijing (CN)

(21) Appl. No.: 15/026,371

(22) PCT Filed: Oct. 2, 2013
(86) PCT No.: PCT/CN2013/084805

§ 371 Date: Mar. 31, 2016

(51) Int. Cl. H04L 29/12; H04L 12/713; H04L 29/06; H04W 36/08

(52) U.S. Cl. CPC H04L 61/2015; H04W 36/08; H04L 45/586; H04L 63/0236; H04W 88/16

(57) ABSTRACT

A gateway, a method performed by the gateway for connecting to an access point of a communication network, a DHCP server and a method performed by the DHCP server for providing IP addresses to a moveable gateway are provided. The gateway is connected to a communication network via a first access point and the gateway is further connectable to a plurality of hosts, which hosts may be connected to the communication network by means of the gateway. The method comprises changing access point from the first access point to a second access point; and requesting an IP address of an uplink IP interface of the gateway from a DHCP server. The method further comprises receiving the IP address of the uplink IP interface of the gateway from the DHCP server; and notifying security applications within the gateway of the gateway information with regards to the received IP address.

### TECHNICAL FIELD

The present disclosure relates to enabling a gateway to move around and in particular to providing the gateway with necessary address information in order to be movable.

### BACKGROUND

Users of different communication devices have high demands on being able to be connected to a communication network by means of e.g. a laptop, a mobile phone, a personal digital assistant and so on. Hereinafter, a communication device is referred to as a host. Hosts may move on a bus, train, car or simply moving from a workplace to a meeting room or a lab. In such situations, a plurality of users may move simultaneously.

In an example, illustrated in FIG. 1a, hosts 120a, 120b, . . . , 120n may be connected to a communication network via a gateway 100. The gateway in turn is connected to an access point 130a, 130b of the communication network 150. If, for example, the gateway is located on a bus, a plurality of hosts may be connected to the gateway which will change access point as the bus travels away from a current access point towards another access point. The bus may provide e.g. a Wireless Local Area Network, WLAN to the passengers on the bus while the backhaul is e.g. Wideband Code Division Multiple Access, WCDMA.

In order to adapt to the gateway moving, the operators need to reconfigure IP addresses for specific interfaces, and they need also some policies configurations such as: Quality of Serve, QoS, and Access Control List, ACL, configurations. This may cost the operator(s) much time and much effort. Some configurations may be turned into automatic scripts for multiple executions. But the IP addresses for the gateway are specific and are not alloyed to conflict or overlap. Further, as the network changes, some configurations related to IP addresses are also needed to be changed.

To handle the gateway moving, only manual adaptations are used. This is not convenient for moving, and high availability is not provided, there are also some potential risks of misconfiguration and stale configuration.

Manual reconfiguration is thus a must for a gateway moving within a communication network this causes high cost; even with assistant of some automatic script(s), also high cost (some scripts are needed to respond to the changes) when IP addresses related configurations changes are invoked while the IP addresses related changes are inevitable to adapt to some network redesign and topology changes.

### SUMMARY

The object is to obviate at least some of the problems outlined above. In particular, it is an object to provide a gateway and a method performed by the gateway for connecting to an access point of a communication network. It is a further object to provide a Dynamic Host Configuration Protocol, DHCP, server and a method performed by the DHCP server for providing IP addresses to a moveable gateway. These objects and others may be obtained by providing a gateway and a DHCP server respectively and a method performed by the gateway and the DHCP server respectively according to the independent claims attached below.

According to an aspect a method performed by a gateway for connecting to an access point of a communication network is provided. The gateway is connected to a communication network via a first access point and wherein the gateway is further connectable to a plurality of hosts, which hosts may be connected to the communication network by means of the gateway. The method comprises changing access point from the first access point to a second access point; and requesting an IP address of an uplink IP interface of the gateway from a DHCP server. The method further comprises receiving the IP address of the uplink IP interface of the gateway from the DHCP server; and notifying security applications within the gateway of the gateway information with regards to the received IP address.

According to an aspect, a method performed by a DHCP server for providing IP addresses to a moveable gateway is provided. The gateway is connected to a communication network via a first access point and wherein the gateway is further connectable to a plurality of hosts, which hosts may be connected to the communication network by means of the gateway. The method comprises receiving a request for an IP address of an uplink IP interface of the gateway from the gateway as the gateway changes access point to the second access point; and assigning an IP address the uplink IP interface of the gateway to an uplink IP interface of the gateway and informing the gateway of the IP address of the uplink IP interface of the gateway. The method further comprises receiving, from the gateway, a request for an IP address of the gateway to be used by hosts connected to the gateway, assigning an IP address to the gateway and informing the gateway of the IP address of the gateway; and adding the IP address of the gateway to a list of a gateway IP pool.

According to an aspect, a gateway adapted for connecting to an access point of a communication network is provided. The gateway is connected to a communication network via a first access point and further connectable to a plurality of hosts, which hosts may be connected to the communication network by means of the gateway. The gateway comprises a changing unit adapted for changing access point from the first access point to a second access point; and a requesting unit adapted for requesting an IP address of the uplink IP interface of the gateway from a DHCP server. The gateway further comprises a receiving unit adapted for receiving the IP address of the uplink IP interface of the gateway from the DHCP server; and a notifying unit adapted for notifying security applications within the gateway of the gateway information with regards to the received IP addresses.

According to an aspect, a DHCP server adapted for providing IP addresses to a moveable gateway is provided. The gateway is connected to a communication network via a first access point and wherein the gateway is further connectable to a plurality of hosts, which hosts may be connected to the communication network by means of the gateway. The DHCP server comprises a receiving unit adapted for receiving a request for an IP address of an uplink IP interface of the gateway from the gateway as the gateway changes access point to the second access point, and an assigning unit adapted for assigning an IP address of the uplink IP interface of the gateway to an uplink IP interface of the gateway. The DHCP server further comprises an informing unit adapted for informing the gateway of the IP address of the uplink IP interface of the gateway. The receiving unit further is adapted for receiving, from the gateway, a request for an IP address of the gateway to be used by hosts connected to the gateway, and the assigning unit further is adapted for assigning an IP address to the gateway. The DHCP server further comprises an adding unit adapted for the IP address of the gateway to a list of a gateway IP pool. The informing unit further is adapted for informing the gateway of the IP address of the gateway.

According to an aspect, a computer program, comprising computer readable code means is provided, which when run in a processing unit comprised in an arrangement in the gateway causes the gateway to perform the corresponding method.

According to an aspect, a computer program, comprising computer readable code means is provided, which when run in a processing unit comprised in an arrangement in the DHCP server causes the DHCP server to perform the corresponding method.

The gateway, the method performed by the gateway, the DHCP server and the method performed by the DHCP server may have several advantages. One possible advantage is that the gateway is easily movable from one place to another place without requiring reconfigurations from the network operator. Still a further possible advantage is that it may provide high availability and smooth reconfiguration with automatic deployment Another possible advantage is that human errors may be avoided which may be likely in a complex network redesign.

### BRIEF DESCRIPTION OF DRAWINGS

Embodiments will now be described in more detail in relation to the accompanying drawings, in which:

FIG. 1a illustrates an example when a gateway moves from a first access point of a communication network to a second access point.

FIG. 1b is a block diagram schematically illustrating a gateway according to an example.

FIG. 1c illustrates an example of a virtual gateway.

FIG. 2a is a flaws hart of a method performed by a movable gateway for connecting to an access point of a communication network according to an exemplifying embodiment.

FIG. 2b is a flowchart of a method performed by a movable gateway for connecting to an access point of a communication network according to still an exemplifying embodiment.

FIG. 2c is a flowchart of a method performed by a movable gateway for connecting to an access point of a communication network according to yet an exemplifying embodiment.

FIG. 2d is a flaws hart of a method performed by a movable gateway for connecting to an access point of a communication network according to an exemplifying embodiment.

FIG. 3a is a flowchart of a method performed by a DHCP server for providing IP addresses to a moveable gateway, wherein the gateway becomes connected to a communication network via an access point according to an exemplifying embodiment.

FIG. 3b is a flowchart of a method performed by a DHCP server for providing IP addresses to a moveable gateway, wherein the gateway becomes connected to a communication network via an access point according to still an exemplifying embodiment.

FIG. 3c is a flowchart of a method performed IN a DHCP server for providing IP addresses to a moveable gateway, wherein the gateway becomes connected to a communication network via an access point according to still an exemplifying embodiment.

FIG. 3d is a flowchart of a method performed by a DHCP server for providing IP addresses to a moveable gateway, wherein the gateway becomes connected to a communication network via an access point according to an exemplifying embodiment.

FIG. 4 is an overview of a DHCP message format.

FIG. 5 is a block diagram of a gateway adapted for connecting to an access point or a communication network according to an exemplifying embodiment.

FIG. 6 is a block diagram of a DHCP server adapted for providing IP addresses to a moveable gateway, wherein the gateway becomes connected to a communication network via an access point according to an exemplifying embodiment.

FIG. 7 is a block diagram of an arrangement in a gateway adapted for connecting to an access point of a communication network according to an exemplifying embodiment.

FIG. 8 is a block diagram of an arrangement in a DHCP server adapted for providing IP addresses to a moveable gateway, wherein the gateway becomes connected to a communication network via an access point according to an exemplifying embodiment.

### DETAILED DESCRIPTION

Briefly described, a moveable gateway and a method performed by the gateway for connecting to an access point of a communication network are prodded. Further a Dynamic Host Configuration Protocol, DHCP, server and a method performed by the DHCP server for providing IP addresses to a moveable gateway, wherein the gateway becomes connected to a communication network are provided.

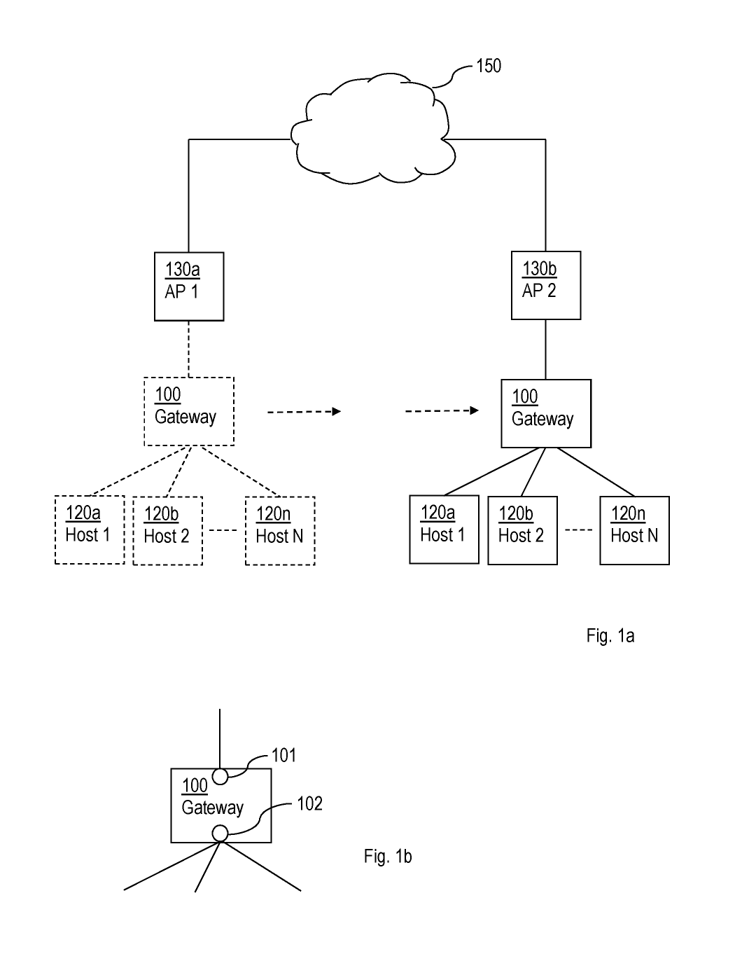

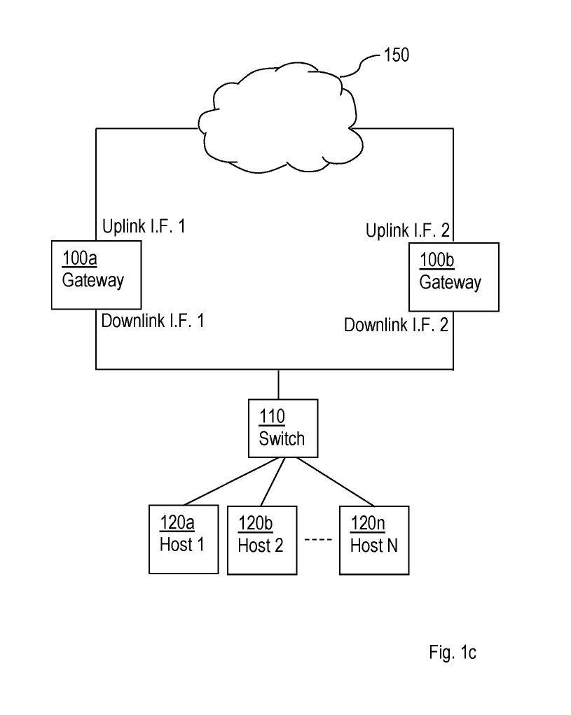

FIG. 1a illustrates an example when a gateway 100 mixes from a first access point 130a of a communication network 150 to a second access point 130b according to an example. The example illustrates that the gateway 100 first is connected to the first access point 130a. Further, a plurality of hosts 120a, 120b, . . . , 120n are connected to the gateway and thus are provided access to the communication network 150 by means of the gateway. In this example, the gateway 100 is moving from the first access point 130a towards the second access point 130b. At a point in time, the gateway becomes connected to the communication network 150 by means of the second access point 130b instead of the first access point 130a. Alternatively, the gateway 100 could manually also become connected to the second access point 130b. When the gateway 100 becomes connected to the second access point 130b, the gateway 100 will need new setting with regard to at least an IP address of the uplink IP interface of the gateway, which will be explained in more detail below.

FIG. 1b is a block diagram schematically illustrating a gateway 100 according to an example. The gateway 100 is illustrated having an uplink IP interface 101 and a downlink IP interface 102. The gateway is connectable to an access point of a communication network, e.g. to the first or second access points 130a or 130b of communication network 150. The uplink IP interface is then associated with or assigned an IP address which is in the same subnet as the access point of the communication network. The downlink IP interface is associated with or assigned the IP address of the gateway, i.e. this is the IP address that hosts connected to the gateway “see” in uplink from the hosts. The uplink and downlink IP interfaces may further comprise subnet mask information and other configuration.

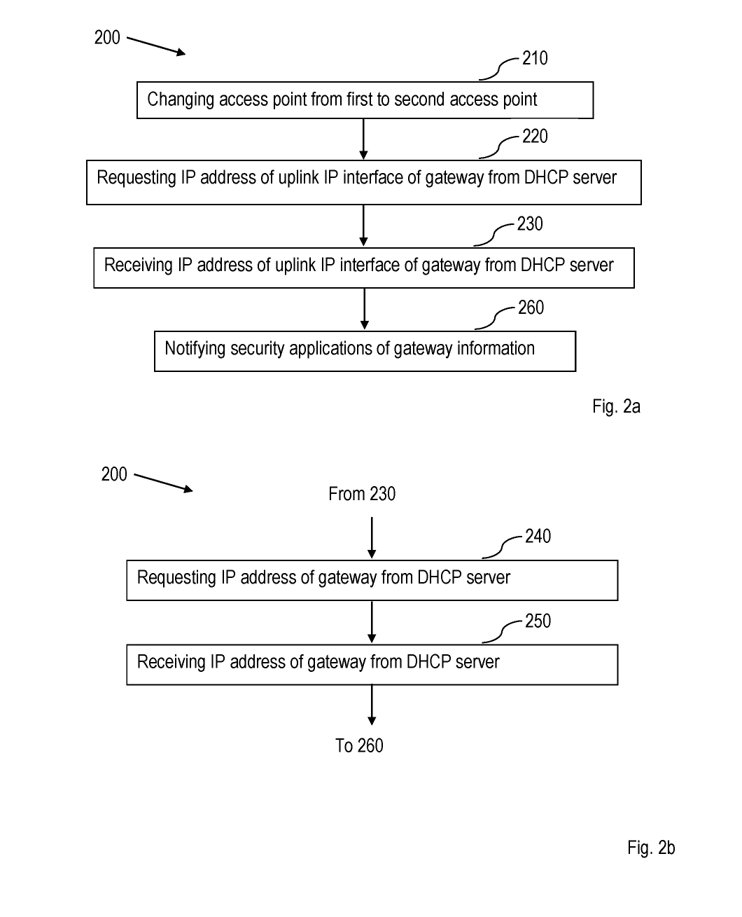

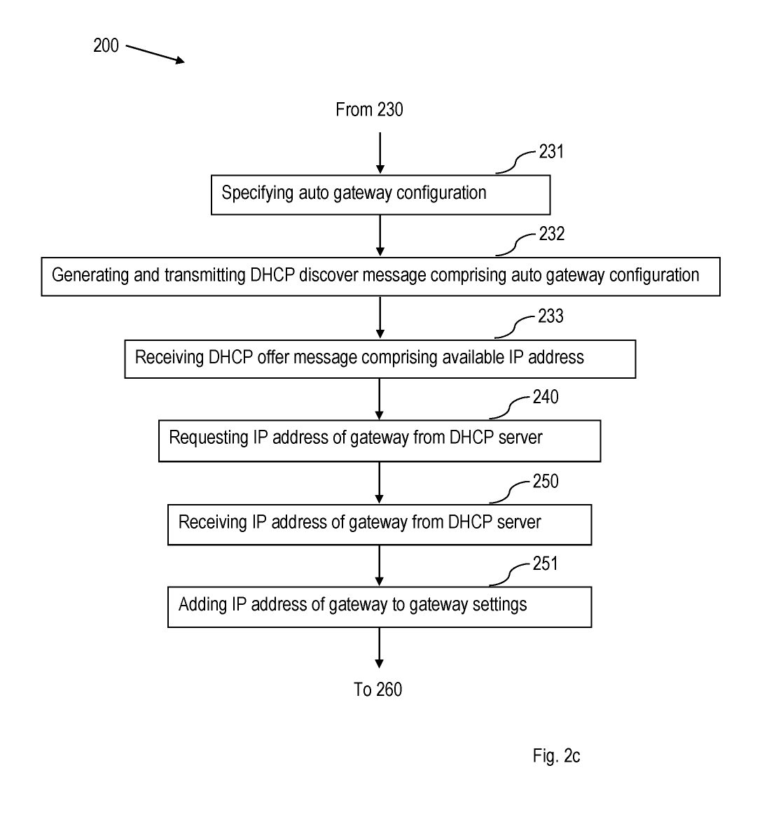

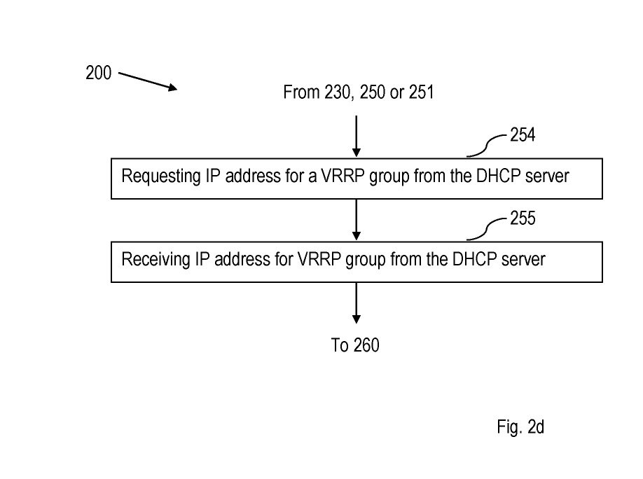

FIG. 2a is a flowchart of a method performed by a movable gateway for connecting to an access point of a communication network according to an exemplifying embodiment. The gateway is connected to a communication network via a first access point and wherein the gateway is further connectable to a plurality of hosts, which hosts may be connected to the communication network by means of the gateway.

FIG. 2a illustrates the method comprising changing 210 access point from the first access point to a second access point; and requesting 220 an IP address of the uplink IP interface of the gateway from a Dynamic Host Configuration Protocol, DHCP, server. The method further comprises receiving 230 the IP address of the uplink IP interface of the gateway from the DHCP server; and notifying 260 security applications within the gateway of the gateway information with regards to the received IP address.

The gateway may e.g. be moving from the first access point to the second access point as described above in conjunction with FIG. 1a. The method comprises changing access point from the first access point to the second assess point. In an example, the gateway is arranged on a bus and on the bus is a plurality of people travelling. Some of the people on the bus are connected to the Internet by means of the gateway, the users being connected to the Internet are hereinafter referred to as hosts (which implies e.g. a laptop, a smartphone or any other device capable of communicating wirelessly with the gateway on the bus). As the bus travels, the bus and thus also the gateway and the hosts are travelling away from the first access point and towards the second access point. At one point in time, the gateway changes 210 access point from the first access point to the second assess point.

As the gateway changes access point from the first to the second access point, the uplink IP interface of the gateway (cf. 101 of FIG. 1b) becomes associated or assigned an “invalid” IP address as this IP address may no longer be used by the gateway. In order to obtain a new IP for the uplink IP interface, the gateway requests 220 the IP address of the IP address of the uplink IP interface of the gateway from a Dynamic Host Configuration Protocol, DHCP, server.

The DCHP server will send the IP address of the uplink IP interface of the gateway as will be described below. The gateway receives 230 the IP address of the uplink IP interface of the gateway from the DHCP server and binds (or associates/allocates) the received IP address of the uplink IP interface of the gateway to the uplink IP interface of the gateway.

The gateway further notifies 260 security applications within the gateway of the gateway information with regards to the received IP address.

In this manner, the gateway may now communicate with the network via the second access point as the gateway has obtained the IP address of the uplink IP interface of the gateway and bound the obtained IP address of the uplink IP interface of the gateway to the uplink IP interface of the gateway.

The method performed by the gateway may have several advantages. One possible advantage is that the gateway is easily movable from one place to another place without requiring reconfigurations from the network operator. Still a further possible advantage is that it may provide high availability and smooth reconfiguration with automatic deployment Another possible advantage is that human errors may be avoided which may be likely in a complex network redesign.

According to an embodiment, illustrated in FIG. 2b, the method further comprises requesting 240 an IP address of the gateway to be used by hosts connected to the gateway from the DHCP server and receiving 250 the IP address of the gateway from the DHCP server, wherein the gateway information to be notified 260 to the security applications within the gateway further comprises the IP address of the gateway.

When the gateway has changed access point from the first to the second access point, the gateway cannot keep the IP address it had when it was connected to the first network node. Thus, it must obtain a new IP address. In order to do so, the gateway requests 240 an IP address of the gateway to be used by hosts connected to the gateway from the DHCP server. The DHCP server will assign an IP address to the gateway and send this IP address to the gateway. This will be explained in more detail below. It shall be pointed out that the gateway may request a plurality of IP addresses and not just one.

The gateway receives 250 the IP address of the gateway from the DHCP server and binds the received IP address of the gateway to the downlink IP interface. The IP address of the gateway, which is also bound to the downlink IP interface, is thus part of the gateway information which is notified 260 to the security applications within the gateway as explained above in conjunction with FIG. 2a.

According to still an embodiment, illustrated in FIG. 2c, the method further comprises specifying 231 an auto gateway configuration under a downlink IP interface.

The auto gateway configuration may specify whether the downlink IP interface can obtain IP address(es) automatically. If enabled, a new DHCP option is included in a DHCP discover (explained in more detail below). The new DHCP option format may be: Code=to be allocated, length=1, value=1/0 (enabled/disabled).

According to yet an embodiment, the method further comprises generating and transmitting 232 a DHCP discover message comprising the auto gateway configuration; receiving 233 a DHCP offer message comprising an available IP address; and requesting 240 the available IP address of gateway to be used by hosts connected to the gateway from the DHCP server. The method further comprises receiving 250 the IP address of the gateway from the DHCP server; and adding 251 IP address of gateway to gateway settings.

When the gateway wants to obtain a new IP address for itself to be bound to the downlink IP interface, the gateway first transmits a DHCP discover message comprising the auto gateway configuration. The gateway can then be said to act as a DHCP client. The DHCP discover message is sent from the uplink IP interface of the gateway.

DHCP clients may request IP addresses via broadcast messages. A DHCP server and clients must be on the same subnet. Therefore, a DHCP server must be available on each subnet. It is sometimes not practical. A DHCP relay agent may solve the problem Via a relay agent, DHCP clients communicate with a DHCP server on another subnet to obtain configuration parameters. Thus, DHCP clients on different subnets can contact the same DHCP server for ease of centralised management and cost reduction.

The gateway thus transmits 232 the DHCP discover message IN broadcasting from the uplink IP interface of the gateway. The DHCP discover message comprises the auto gateway configuration. The DHCP server will assign an IP address to the gateway and send that (or those) IP address(es) to the gateway in a DHCP offer, which will also be explained in more detail below.

The gateway receives 233 the DHCP offer message comprising an available IP address to be assigned to the gateway. The gateway selects the IP address(es) and requests 240 the IP address from the DHCP server, by sending a DHCP request message comprising the IP address. The gateway then receives 250 a DHCP acknowledgement message and thus receives the IP address of the gateway from the DHCP server. The DHCP request message if also sent from the uplink IP interface of the gateway.

Once the gateway has obtained the IP address of the gateway, the gateway binds the IP address of the gateway to the downlink IP interface, and adds 251 the IP address of the gateway to the gateway settings. This further enables the gateway to be easily movable from one place to another place without requiring reconfigurations from the network operator. A further possible advantage is that this may provide high availability and smooth reconfiguration with automatic deployment Another possible advantage is that human errors may be avoided which may be likely in a complex network redesign.

According to an embodiment, illustrated in FIG. 2d, the method further comprises requesting 254 and receiving 255 an IP address for a Virtual Router Redundancy Protocol, VRRP, group from the DHCP server, wherein the gateway information to be notified 260 to the security applications within the gateway further comprises the IP address of the VRRP group.

The gateway may be part of a VRRP group. If so, the gateway requests 254 an IP address for the VRRP group from the DHCP server, and subsequently receives 255 the IP address for the VRRP group from the DHCP server. The IP address of the VRRP group is part of the gateway information which is notified 260 to the security application within the gateway as described above in conjunction with FIG. 2a.

The gateway may be a virtual gateway being part of a virtual redundant group, wherein the method comprises specifying 231 an auto gateway configuration under a downlink IP interface, specifying a VRRP configuration comprising number of virtual IP addresses under the downlink IP interface, generating and transmitting a DHCP discover message comprising the auto gateway configuration and the VRRP configuration to the DHCP server.

When the gateway is a virtual gateway being part of a virtual redundant group, the gateway specifies 231 the auto gateway configuration under a downlink IP interface and specifies a VRRP configuration comprising number of virtual IP addresses under the downlink IP interface. Then, when the gateway generates the DHCP discover message, the gateway inserts both the gateway configuration and the VRRP configuration into the DHCP discover message before and transmitting the DHCP discover message to the DHCP server.

In this manner, the DHCP server is enabled to take appropriate actions as will be described below.

The method may further comprise receiving a DHCP offer message comprising an available IP address from the DHCP server, transmitting a DHCP request for the IP address to the DHCP server, receiving a DHCP acknowledgment from the DHCP server, adding 251 IP address or gateway to gateway settings and notifying 260 security applications within the gateway of the gateway information with regards to the received IP address.

When the DHCP server receives DHCP disc over message from the gateway comprising the auto gateway configuration and the VRRP configuration to the DHCP server, the DHCP server will send a DHCP offer message comprising an available IP address. The actions of the DHCP server will be explained in more detail below. The gateway receives the DHCP offer message comprising the available IP address(s). The gateway transmits a DHCP request for the IP address to the DHCP server. The gateway subsequently receives a DHCP acknowledgment from the DHCP server informing the gateway that the requested IP address(es) have been assigned to the gateway. The gateway then adds the IP address(es) to the gateway settings and notifies security applications within the gateway of the gateway information with regards to the received IP addresses.

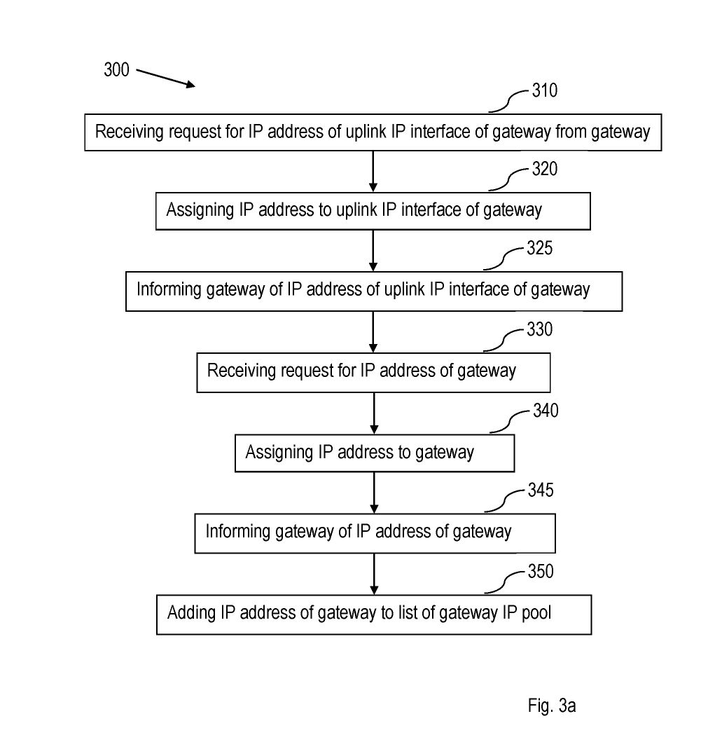

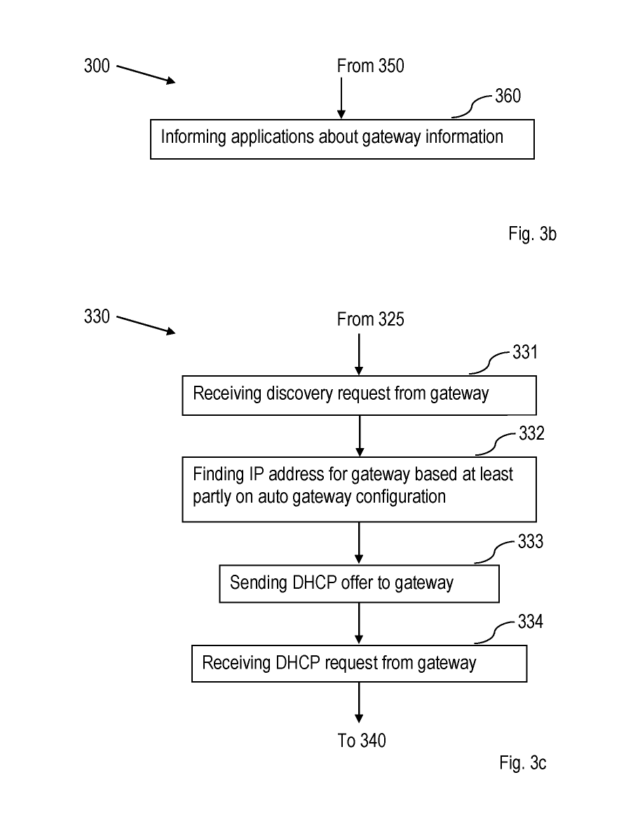

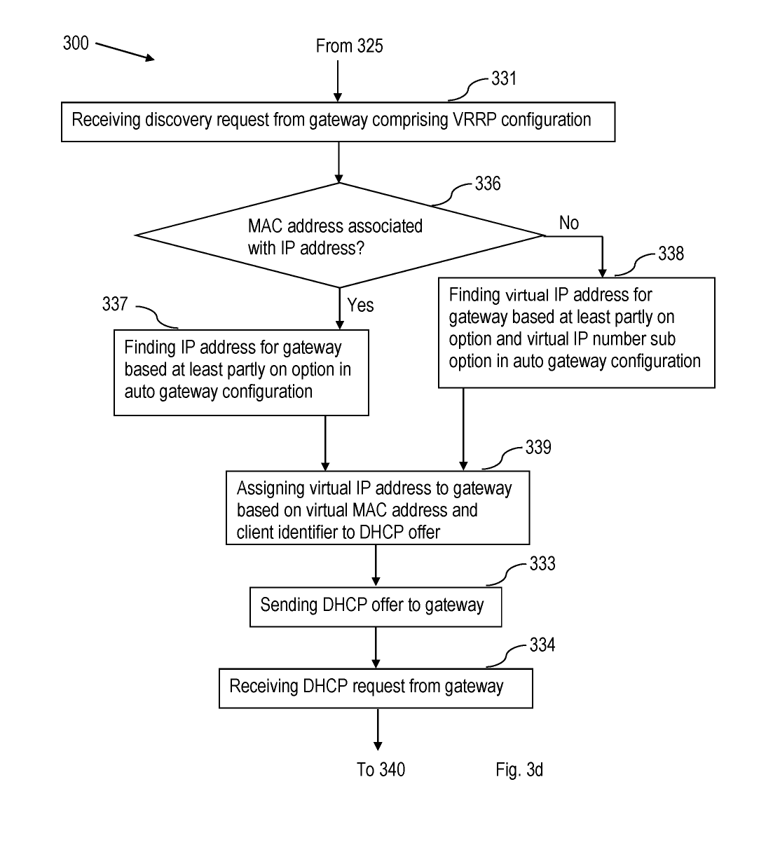

Embodiments herein also relate to a method performed by a DHCP server for providing IP addresses to a moveable gateway, wherein the gateway is connected to a communication network via a first access point and wherein the gateway is further connectable to a plurality of hosts, which hosts may be connected to the communication network by means of the gateway. Embodiments of such a method will now be described with reference to FIGS. 3a-3d.

FIG. 3a describe the method comprising receiving 310 a request for an IP address of the uplink IP interface of the gateway from the gateway as the gateway changes access point to the second access point; assigning 320 an IP address the uplink IP interface of the gateway to an uplink IP interface of the gateway and informing 325 the gateway of the IP address of the uplink IP interface of the gateway; receiving 330, from the gateway, a request for an IP address of the gateway to be used by hosts connected to the gateway; assigning 340 an IP address to the gateway and informing 345 the gateway of the IP address of the gateway; and adding 350 the IP address of the gateway to a list of a gateway IP pool.

The DHCP server receives 310 the request for an IP address of a second access point from the gateway as the gateway changes access point to the second access point. The request may be received by means of a DHCP discover message. As described above, the IP addresses of at least the uplink IP interface changes as the gateway changes access point. The DHCP server thus assigns 320 the IP address of the second access point to the uplink IP interface of the gateway. The DHCP server further informs 325 the gateway of the IP address of the second access point, e.g. by sending a DHCP offer message comprising the IP address of the second access point. Thereafter, further DHCP messages may be changed as explained above, e.g. the gateway sending a DHCP request message comprising the IP address of the second access point and the DHCP server confirming the IP address by sending a DHCP acknowledgement message to the gateway.

Further gateway requests an IP address of the gateway from the DHCP server. This request is received 330 by the DHCP server, e.g. by means of a DHCP discover message. The DHCP server then assigns 340 an IP address to the gateway and informs 345 the gateway of the IP address of the gateway, e.g. by sending a DHCP offer message comprising the IP address of the gateway. Thereafter, further DHCP messages may be exchanged as explained above, e.g. the gateway sending a DHCP request message comprising the IP address of the gateway and the DHCP server confirming the IP address by sending a DHCP acknowledgement message to the gateway.

The DHCP server further adds 350 the IP address of the gateway to a list of a gateway IP pool.

The method performed by the DHCP server may have the same or similar advantages as the method performed by the gateway. One possible advantage is that the gateway is easily movable from one place to another place without requiring reconfigurations from the network operator. Still a further possible advantage is that it may provide high availability and smooth reconfiguration with automatic deployment. Another possible advantage is that human errors may be avoided which may be likely in a complex network redesign.

According to an embodiment, illustrated in FIG. 3b, the method further comprises informing 360 applications about the information about the gateway relating to the assigned IP address.

The applications may be e.g. Quality of Service applications and/or an IP address based Access Control List, ACL. These applications may need to know the respective IP addresses of the uplink and downlink IP interfaces.

According to still an embodiment, illustrated in FIG. 3c, receiving 330, from the gateway, the request for the IP address of the gateway comprises receiving 331 a DHCP discovery message comprising auto gateway configuration information, finding 332 available IP address based at least partly on the auto gateway configuration, and sending 333 a DHCP offer comprising available IP address to the gateway.

As explained abase, the request for the IP address of the gateway may be sent from the gateway to the DHCP server by means of a DHCP discovery message. The message comprises auto gateway configuration information of the gateway. In this manner, the DHCP server is provided with necessary information in order to find 332 available an IP address based at least partly on the auto gateway configuration. Then the DHCP server sends 333 a DHCP offer comprising available IP address to the gateway.

Receiving 330, from the gateway, the request for the IP address of the gateway may further comprise receiving 334 a DHCP request from the gateway, assigning 340 the available IP address based on the DHCP offer and informing the gateway of the IP address of the gateway by sending a DHCP acknowledgement to the gateway.

The DHCP server has previously received the DHCP discovery message comprising the auto gateway configuration information of the gateway and have found, or assigned, the available IP address based at least partly on the auto gateway configuration, and sent 333 a DHCP offer message comprising available IP address to the gateway. The gateway may select the available IP address and then send a DHCP request for the available IP address, which is received 334 by the DHCP server, see e.g. FIG. 3c. The DHCP server then assigns 340 the available IP address based on the DHCP offer and informs 345 the gateway of the IP address of the gateway by sending a DHCP acknowledgement to the gateway.

According to yet an embodiment, illustrated in FIG. 3d, the received request 331 for the IP address of the gateway to be used by hosts connected to the gateway comprises auto gateway configuration information and a Virtual Router Redundancy Protocol, VRRP, configuration, the method further comprising determining 336 whether the a virtual Medium Access Control, MAC, address is associated with IP addresses; and if so then the method comprises finding 337 available IP addresses for the gateway based on an auto gateway option comprised in the auto gateway configuration; or if not then the method comprises finding 338 available virtual IP addresses for the gateway based on an auto gateway option and a virtual IP number sub option comprised in the auto gateway configuration.

The gateway may part of a virtual gateway, see e.g. FIG. 1c. In this scenario, the Uplink IP interface 1 and Downlink IP interface 1 on Gateway 100a and Uplink IP interface 2 and Downlink IP interface 2 on Gateway 100b are configured to automatically obtain IP address from the DHCP Server. Furthermore, the Downlink IP interface 1 and Downlink IP interface 2 have some same virtual IP addresses so that a redundant gateway mechanism is provided.

The auto gateway configuration information may specify whether the downlink IP interface can obtain IP address(es) automatically. The VRRP configuration comprises the virtual group id, the number of virtual IP addresses. And the virtual MAC address of the virtual group is 00-00-5e-00-01-xx (xx represents virtual group id). A virtual MAC address could associate with several virtual IP addresses

The method comprises the DHCP server determining 336 whether the virtual MAC address is associated with an IP address. Any such association may have been done previously and thus need not be done anew. If the virtual MAC address is associated with IP addresses, then the DHCP server will only associate IP address for the specified IP interface and does not assign the virtual IP addresses for virtual group again. Thus the method comprises finding 337 IP addresses for the gateway based on an auto gateway option comprised in the auto gateway configuration.

If the virtual MAC address is not associated with IP addresses, then the method comprises finding 338 virtual IP addresses for the gateway based on a gateway option and a virtual IP number sub option comprised in the auto gateway configuration. In this scenario, it means this is the first time that the gateway in the virtual group obtains the IP addresses. The DHCP server will find and assign the appropriate IP addresses in the IP pool based on the auto gateway option and optionally also based on a local IP pool configuration. Some separate IP pools may be used for auto gateway application, e.g. specified during network plan and design. Here DHCP server will assign both IP address for specified IP interface and also the virtual IP addresses for virtual group.

The auto gateway option and number of virtual IP addresses sub option may be configured on the downlink IP interface, and may be carried in the DHCP disc aver message generated by the gateway and also carried in the DHCP message sent from gateway to DHCP Server. The auto gateway option may be carried as a separate DHCP option, and number of virtual IP addresses sub option is under the auto gateway option.

In the virtual gateway scenario, the virtual redundant group will associate with virtual MAC, 0000-5e00-01xx (here xx means virtual group id). And maybe several gateway groups use same virtual groups allowed by protocol. So DHCP server should identify the virtual gateways with DHCP client id (DHCP Option 61). Currently, most DHCP servers and DHCP clients can use DHCP client id to identify DHCP client instead of default using MAC address to identify of DHCP Client.

Here, the DHCP client id may consist of a logical name plus the virtual MAC address for the virtual group.

DHCP Server also has some special configurations which specify the appropriate IP pools associated with the gateway.

The method may further comprise assigning 339 virtual IP addresses based on the virtual MAC address and client identifier to an DHCP offer and sending 333 the DHCP offer to the gateway, receiving 334 a DHCP request for the virtual IP addresses from the gateway, assigning 340 the virtual IP addresses to the gateway, informing 345 the gateway of the IP address of the gateway by sending an acknowledgement to the gateway and adding 350 the IP address of the gateway to a list of an gateway IP pool.

The DHCP server assigns virtual IP addresses. For assigning non-virtual IP addresses, DHCP server may only use the MAC address of gateway, but for virtual IP address, the DHCP server needs to use a virtual MAC address and client identifier in order to identify VRRP redundant group.

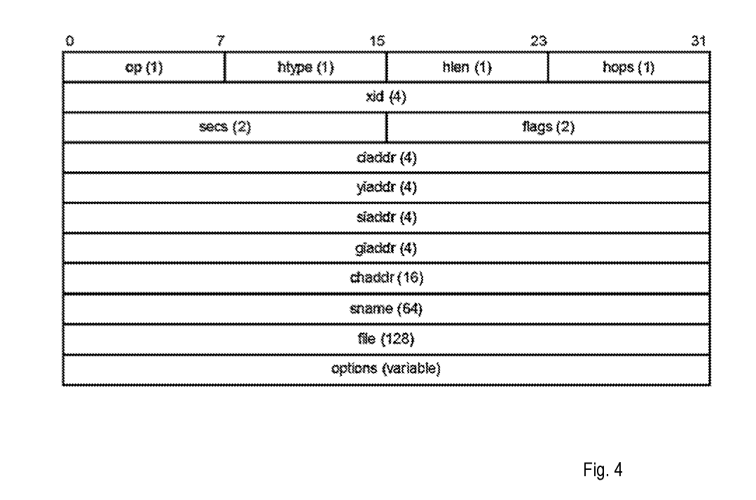

FIG. 4 is an overview of a DHCP message format. It is based on Bootstrap Protocol, BOOTP, message format and involves eight types. These types of messages have the same format except that some fields have different values. The numbers in parentheses indicate the size of each field in bytes.

op: Message type defined in option field. 1=REQUEST, 2=REPLY
htype,hlen: Hardware address type and length of a DHCP client.
hops: Number of relay agents a request message traveled.
xid: Transaction ID, a random number chosen by the client to identify an IP address allocation.
secs: Filled in by the client, the number of seconds elapsed since the client began address acquisition or renewal process. Currently this field is reserved and set to 0.
flags: The leftmost bit is defined as the BROADCAST (8) flag. If this flag is set to 0, the DHCP server sent a reply back by unicast; if this flag is set to 1, the DHCP server sent a reply back by broadcast. The remaining bits of the flags field are reserved for future use.
ciaddr: Client IP address.
yiaddr: ‘your’ (client) IP address, assigned by the server.
siaddr: Server IP address, from which the clients obtained configuration parameters.
giaddr: The first relay agent IP address a request message traveled.
chaddr: Client hardware address.
sname: The server host name, from which the client obtained configuration parameters.
file: Bootfile name and routing information, defined by the server to the client.
options: Optional parameters field that is variable in length, which includes the message type, lease, DNS IP address, WINS IP address and so forth.

Embodiments herein also relate to a gateway adapted for connecting to an access point of a communication network. The gateway is connected to a communication network via a first access point and wherein the gateway is further connectable to a plurality of hosts, which hosts may be connected to the communication network by means of the gateway. The gateway has the same technical features, objects and advantages as the method performed by the gateway. The gateway will be described in brief in order to avoid unnecessary repetition.

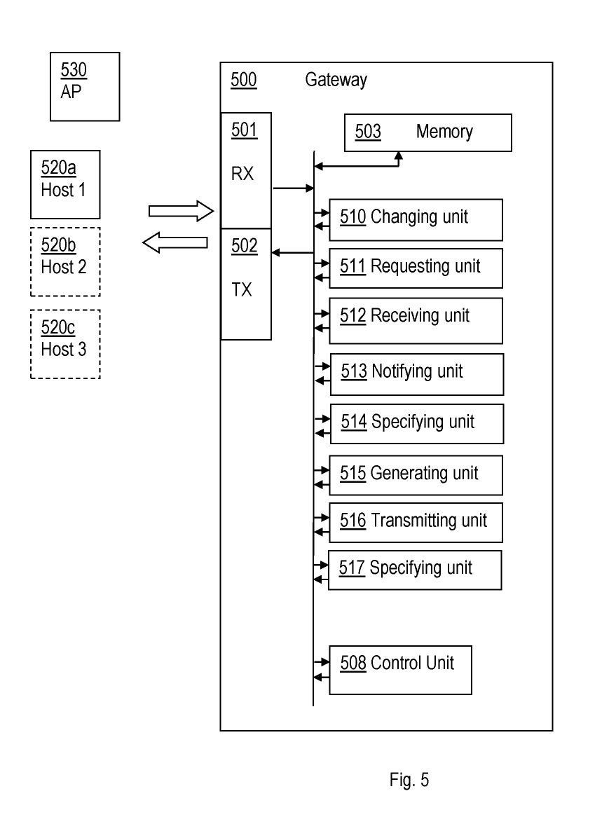

FIG. 5 discloses the gateway comprising a changing unit 510 adapted for changing access point from the first access point to a second access point; a requesting unit 511 adapted for requesting an IP address of the uplink IP interface of the gateway from a Dynamic Host Configuration Protocol, DHCP, server; a receiving unit 512 adapted for receiving the IP address of the uplink IP interface of the gateway from the DHCP server, and a notifying unit 513 adapted for notifying security applications within the gateway of the gateway information with regards to the received IP addresses.

FIG. 5 also illustrates the gateway communicating with, or being connected to, an access point 530 and a plurality of hosts 520a-520b (at least one host).

The gateway has the same possible advantages as the method performed by the gateway. One possible advantage is that the gateway is easily movable from one place to another place without requiring reconfigurations from the network operator. Still a further possible advantage is that it may provide high availability and smooth reconfiguration with automatic deployment. Another possible advantage is that human errors may be avoided which may be likely in a complex network redesign.

According to an embodiment, the requesting unit 511 further is adapted for requesting an IP address of the gateway to be used by hosts connected to the gateway from the DHCP server and wherein the receiving unit 512 further is adapted for receiving the IP address of the gateway from the DHCP server, wherein the gateway information to be notified to the security applications within the gateway further comprises the IP address of the gateway.

According to yet an embodiment, the gateway further comprises a specifying unit 514 adapted for specifying an auto gateway configuration under a downlink IP interface.

According to still an embodiment, the gateway further comprises a generating unit 516 and a transmitting unit 516 adapted for generating and transmitting a DHCP discover message comprising the auto gateway configuration, wherein the receiving unit 512 further is adapted for receiving a DHCP offer message comprising an available IP address, the requesting unit 511 is adapted for requesting the available IP address of gateway to be used by hosts connected to the gateway from the DHCP server and the receiving unit 512 is adapted for receiving the IP address of the gateway from the DHCP server, and adding IP address of gateway to gateway settings.

According to another embodiment, the requesting unit 511 and receiving unit 512 further are adapted for requesting and receiving an IP address for a Virtual Router Redundancy Protocol, VRRP, group from the DHCP server, wherein the gateway information to be notified to the security applications within the gateway further comprises the IP Address of the VRRP group.

According to yet an embodiment, the gateway is a virtual gateway being part of a virtual redundant group, the gateway 500 further comprising a specifying unit 517 adapted for specifying an auto gateway configuration under a downlink IP interface, specifying a Virtual Router Redundancy Protocol, VRRP, configuration comprising number of virtual IP addresses under the downlink IP interface, wherein the generating unit 515 and the transmitting unit 516 are adapted for generating and transmitting a DHCP discos er message comprising the auto gateway configuration and the VRRP configuration to the DHCP server.

According to still an embodiment, the receiving unit 512 further is adapted for receiving a DHCP offer message comprising an available IP address from the DHCP server, wherein the transmitting unit 516 further is adapted for transmitting a DHCP request for the IP address to the DHCP server, the receiving unit 512 is adapted for receiving a DHCP acknowledgment from the DHCP server and adding IP address of gateway to gateway settings and wherein the notifying unit 513 is adapted for notifying security applications within the gateway of the gateway information with regards to the received IP addresses.

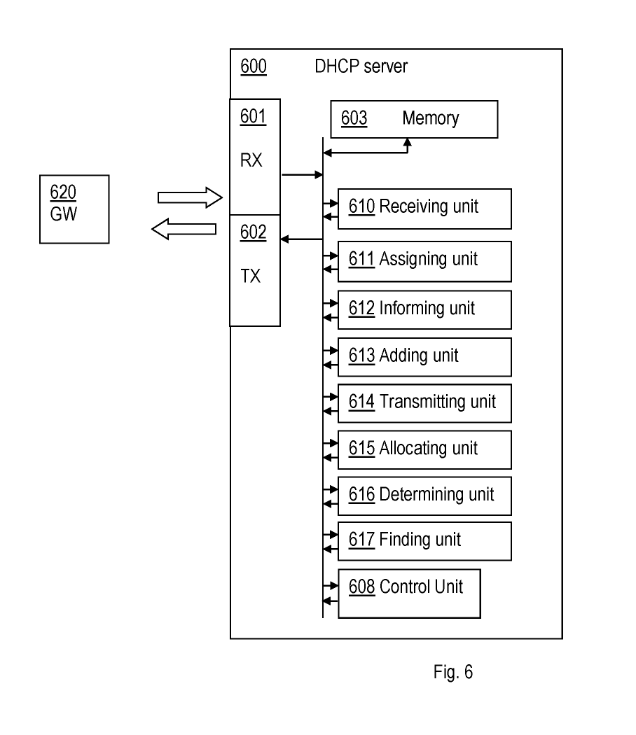

Embodiments herein also relate to a DHCP server adapted for providing IP addresses to a moveable gateway, wherein the gateway is connected to a communication network via a first access point and wherein the gateway is further connectable to a plurality of hosts, which hosts may be connected to the communication network by means of the gateway. Exemplifying embodiments of such a DHCP server will now be described with reference to FIG. 6.

FIG. 6 illustrates the DHCP server comprising a receiving unit 610 adapted for receiving a request for an IP address of an uplink IP interface of the gateway from the gateway 620 as the gateway 620 changes access point to the second access point, and an assigning unit 611 adapted for assigning an IP address of the uplink IP interface of the gateway 620 to an uplink IP interface of the gateway 620. The DHCP server further comprises an informing unit 612 adapted for informing the gateway 620 of the IP address of the uplink IP interface of the gateway 620. The receiving unit 610 further is adapted for receiving, from the gateway 620, a request for an IP address of the gateway 620 to be used by hosts connected to the gateway 620, and the assigning unit 611 further is adapted for assigning an IP address to the gateway 620. The DHCP server 600 further comprises an adding unit 613 adapted for the IP address of the gateway 620 to a list of an gateway IP pool. The informing unit 612 further is adapted for informing the gateway 620 of the IP address of the gateway 620.

The DHCP server has the same advantages as the method performed by the DHCP server. One possible advantage is that the gateway is easily me able from one place to another place without requiring reconfigurations from the network operator. Still a further possible advantage is that it may provide high availability and smooth reconfiguration with automatic deployment. Another possible advantage is that human errors may be avoided which may be likely in a complex network redesign.

According to an embodiment, the informing unit 612 further is adapted for informing applications about the information about the gateway 620 relating to the assigned IP address.

According to yet an embodiment, the receiving unit 610 further is adapted for receiving, from the gate way 620, the request for the IP address of the gateway by receiving a DHCP discovery message comprising auto gateway configuration information and finding available IP address based at least partly on the auto gateway configuration, the DHCP server 600 further comprising a transmitting unit 614 adapted for sending a DHCP offer comprising available IP address to the gateway 620.

According to still an embodiment, the receiving unit 610 is adapted for receiving, from the gateway 620, the request for the IP address of the gateway by receiving a DHCP request from the gateway 620, the DHCP server 600 further comprising an allocating unit 615 adapted for allocating the available IP address based on the DHCP offer and sending a DHCP acknowledgement to the gateway 620.

According to an embodiment, the received request for the IP address of the gateway 620 to be used by hosts connected to the gateway 620 comprises auto gateway configuration information and a Virtual Router Redundancy Protocol, VRRP, configuration, the DHCP server 600 further comprising a determining unit 616 adapted for determining whether the a virtual Medium Access Control, MAC, address is associated with IP addresses; and if so then the DHCP server 600 comprises a finding unit 617 adapted for finding available IP addresses for the gateway 620 based on a gateway option comprised in the auto gateway configuration; or if not then the finding unit 617 is adapted for finding available virtual IP addresses for the gateway 620 based on a gateway option and a virtual IP number sub option comprised in the auto gateway configuration.

According to yet an embodiment, the allocating unit 615 further is adapted for allocating virtual IP addresses based on the virtual MAC address and client identifier to an DHCP offer, wherein the transmitting unit 614 is adapted for sending the DHCP offer to the gateway 620, the receiving unit 610 is adapted for receiving a DHCP request for virtual IP addresses from the gateway 620, the allocating unit 616 adapted for allocating the virtual IP address to the gateway 620, and the transmitting unit 614 is adapted for sending an acknowledgement to the gateway 620 and adding the IP address of the gateway to a list of an gateway IP pool.

In FIG. 5, the gateway 500 is also illustrated comprising a receiving arrangement 501 and a transmitting arrangement 502. Through these two arrangements, the gateway 500 is adapted to communicate with other nodes and/or entities in a wireless communication network. The receiving arrangement 501 may comprise more than one receiving arrangement. For example, the receiving arrangement 501 may be connected to both a wire and an antenna, by means of which the gateway 500 is enabled to communicate with other nodes and/or entities in the wireless communication network. Similarly, the transmitting arrangement 502 may comprise more than one transmitting arrangement, which in turn are connected to both a wire and an antenna, by means of which the gateway 500 is enabled to communicate with other nodes and/or entities in the wireless communication network. The Gateway 500 further comprises a memory 503 for storing data. Further, the gateway 500 is illustrated comprising a control or processing unit 508 which in turns is connected to the different units 510-517. It shall be pointed out that this is merely an illustrative example and the gateway 500 may comprise more, less or other units or modules which execute the functions of the gateway 500 in the same manner as the units illustrated in FIG. 5.

It should be noted that FIG. 6 merely illustrates various functional units in the gateway 500 in a logical sense. The functions in practice may be implemented using any suitable software and hardware means/circuits etc. Thus, the embodiments are generally not limited to the shown structures of the gateway 500 and the functional units. Hence, the previously described exemplary embodiments may be realised in many ways. For example, one embodiment includes a computer-readable medium having instructions stored thereon that are executable by the control or processing unit 508 for executing the method steps in the gateway 500. The instructions Executable by the computing system and stored on the computer-readable medium perform the method steps of the gateway 500 as set forth in the claims.

In FIG. 6, the DHCP server 600 is also illustrated comprising a receiving arrangement 601 and a transmitting arrangement 602. Through these two arrangements, the DHCP server 600 is adapted to communicate with other nodes and/or entities in the wireless communication network. The receiving arrangement 601 may comprise more than one receiving arrangement. For example, the receiving arrangement 601 may be connected to both a wire and an antenna, by means of which the DHCP server 600 is enabled to communicate with other nodes and/or entities in the wireless communication network. Similarly, the transmitting arrangement 602 may comprise more than one transmitting arrangement, which in turn are connected to both a wire and an antenna, by means of which the DHCP server 600 is enabled to communicate with other nodes and/or entities in the wireless communication network. The DHCP server 600 further comprises a memory 603 for storing data. Further, the DHCP server 600 is illustrated comprising a control or processing unit 608 which in turns is connected to the different units 610-617. It shall be pointed out that this is merely an illustrative example and the DHCP server 600 may comprise more, less or other units or modules which execute the functions of the DHCP server 600 in the same manner as the units illustrated in FIG. 6.

It should be noted that FIG. 6 merely illustrates various functional units in the DHCP server 600 in a logical sense. The functions in practice may be implemented using any suitable software and hardware means/circuits etc. Thus, the embodiments are generally not limited to the shown structures of the DHCP server 600 and the functional units. Hence, the previously described exemplary embodiments may be realised in many ways. For example, one embodiment includes a computer-readable medium having instructions stored thereon that are executable by the control or processing unit 608 for executing the method steps in the DHCP server 600. The instructions executable by the computing system and stored on the computer-readable medium perform the method steps of the DHCP server 600 as set forth in the claims.

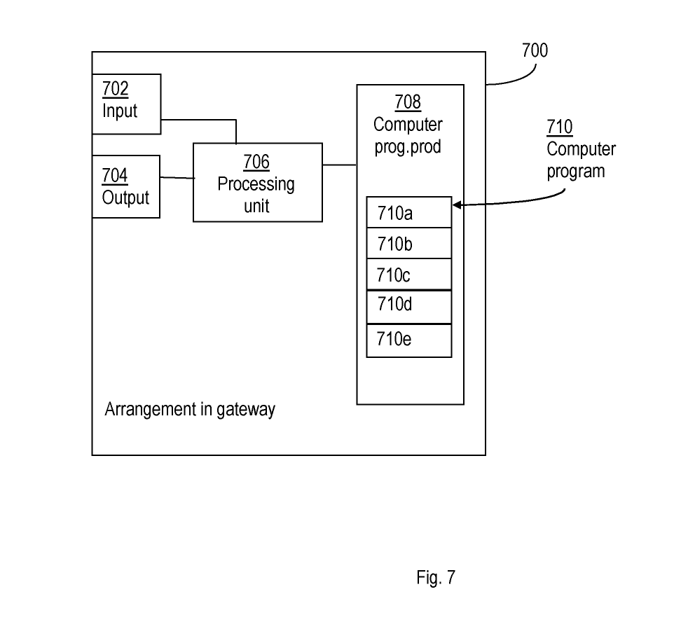

FIG. 7 schematically shows an embodiment of an arrangement in a gateway 700. Comprised in the gateway 700 are here a processing unit 706, e.g. with a DSP (Digital Signal Processor). The processing unit 706 may be a single unit or a plurality of units to perform different actions of procedures described herein. The gateway 700 may also comprise an input unit 702 for receiving signals from other entities, and an output unit 704 for providing signal(s) to other entities. The input unit and the output unit may be arranged as an integrated entity or as illustrated in the example of FIG. 5, as one or more interfaces 501/502.

Furthermore, the gateway 700 comprises at least one computer program product 708 in the form of a non-volatile memory, e.g. an EEPROM (Electrically Erasable Programmable Read-Only Memory), a flash memory and a hard drive. The computer program product 708 comprises a computer program 710, which comprises code means, which when executed in the processing unit 706 in the gateway 700 causes the gateway 700 to perform the actions e.g. of the procedure described earlier in conjunction with FIGS. 2a-2d.

The computer program 710 may be configured as a computer program code structured in computer program modules 710a-710e. Hence, in an exemplifying embodiment, the code means in the computer program of the gateway 700 comprises a changing unit, or module, for changing access point from the first access point to a second access point. The computer program further comprises a requesting unit, or module, for requesting an IP address of the uplink IP interface of the gateway from a DHCP server. The computer program further comprises a receiving unit, or module, for receiving the IP address of the uplink IP interface of the gateway from the DHCP server; and a notifying unit, or module, for notifying security applications within the gateway of the gateway information with regards to the received IP address.

The computer program modules could essentially perform the actions of the flow illustrated in FIGS. 2a-2d, to emulate the gateway 700. In other words, when the different computer program modules are executed in the processing unit 706, they may correspond to the units 510-517 of FIG. 5.

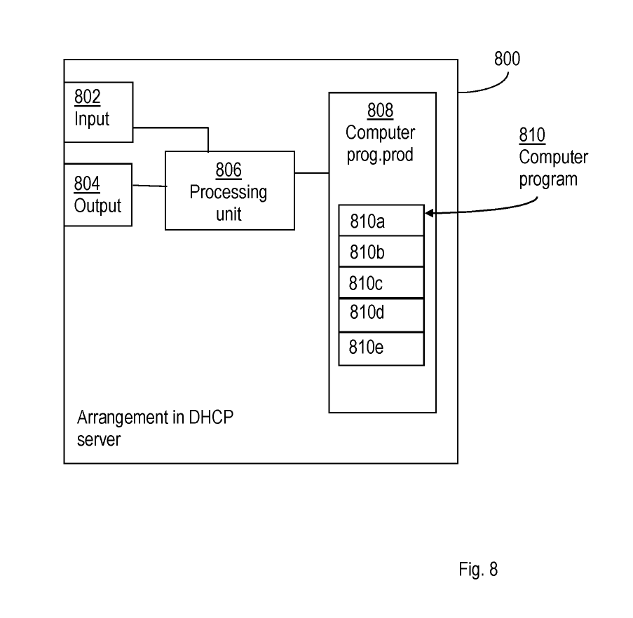

FIG. 8 schematically shows an embodiment of an arrangement in a DHCP server 800. Comprised in the DHCP server 800 are here a processing unit 806, e.g. with a DSP (Digital Signal Processor). The processing unit 806 may be a single unit or a plurality of units to perform different actions of procedures described herein. The DHCP server 800 may also comprise an input unit 802 for receiving signals from other entities, and an output unit 804 for providing signal(s) to other entities. The input unit and the output unit may be arranged as an integrated entity or as illustrated in the example of FIG. 6, as one or more interfaces 601/602.

Furthermore, the DHCP server 800 comprises at least one computer program product 808 in the form of a non-volatile memory, e.g. an EEPROM (Electrically Erasable Programmable Read-Only Memory), a flash memory and a hard drive. The computer program product 808 comprises a computer program 810, which comprises code means, which when executed in the processing unit 806 in the DHCP server 800 causes the DHCP server 800 to perform the actions e.g. of the procedure described earlier in conjunction with FIGS. 3a-3d.

The computer program 810 may be configured as a computer program code structured in computer program modules 810a-810e. Hence, in an exemplifying embodiment, the code means in the computer program of the DHCP server 800 comprises a receiving unit, or module, for receiving a request for an IP address of an uplink IP interface of the gateway from the gateway as the gateway changes access point to the second access point. The computer program further comprises an assigning unit, or module, for assigning an IP address of the uplink IP interface of the gateway to an uplink IP interface of the gateway and an informing unit, or module, for informing the gateway of the IP address of the uplink IP interface of the gateway. The receiving unit, or module further enables receiving, from the gateway, a request for an IP address of the gateway to be used by hosts connected to the gateway; and the assigning unit, or module, enables assigning an IP address to the gateway. The informing unit, or module, further enables informing the gateway of the IP address of the gateway by sending a DHCP acknowledgement to the gateway. The computer program further comprises an adding unit, or module, for adding the IP address of the gateway to a list of an gateway IP pool.

The computer program modules could essentially perform the actions of the flow illustrated in FIG. 3a-3d, to emulate the DHCP server 800. In other words, when the different computer program modules are executed in the processing unit 806, they may correspond to the units 610-617 of FIG. 6.

Although the code means in the respective embodiments disclosed above in conjunction with FIGS. 5 and 6 are implemented as computer program modules which when executed in the respective processing unit causes the gateway and the DHCP server respectively to perform the actions described above in the conjunction with figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as ASICs (Application Specific Integrated Circuit). The processor may also comprise board memory for caching purposes. The computer program may be carried by a computer program product connected to the processor. The computer program product may comprise a computer readable medium on which the computer program is stored. For example, the computer program product may be a flash memory, a RAM (Random-access memory) ROM (Read-Only Memory) or an EEPROM, and the computer program modules described above could in alternative embodiments be distributed on different computer program products in the form of memories within the gateway and the DHCP server respectively.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. A method performed by a moveable gateway, wherein the gateway is connected to a communication network via a first access point and wherein the gateway is further connectable to a plurality of hosts, which hosts may be connected to the communication network by means of the gateway, the method comprising:
changing access point from the first access point to a second access point,
requesting an IP address of an uplink IP interface of the gateway from a Dynamic Host Configuration Protocol, DHCP, server,
receiving the IP address of the uplink IP interface of the gateway from the DHCP server, and
notifying security applications within the gateway of the gateway information with regards to the received IP address.

2. A method according to claim 1, further comprising requesting an IP address of the gateway to be used by hosts connected to the gateway from the DHCP server and receiving the IP address of the gateway from the DHCP server, wherein the gateway information to be notified to the security applications within the gateway further comprises the IP address of the gateway.

3. A method according to claim 2, further comprising specifying an auto gateway configuration under a downlink IP interface.

4. A method according to claim 3, further comprising generating and transmitting a DHCP discover message comprising the auto gateway configuration, receiving a DHCP offer message comprising an available IP address, requesting the available IP address of gateway to be used by hosts connected to the gateway from the DHCP server and receiving the IP address of the gateway from the DHCP server, and adding IP address of gateway to gateway settings.

5. A method according to claim 1, further comprising requesting and receiving an IP address for a Virtual Router Redundancy Protocol, VRRP, group from the DHCP server, wherein the gateway information to be notified to the security applications within the gateway further comprises the IP Address of the VRRP group.

6. A method according to claim 1, wherein the gateway is a virtual gateway being part of a virtual redundant group, the method comprising specifying an auto gateway configuration under a downlink IP interface, specifying a Virtual Router Redundancy Protocol, VRRP, configuration comprising number of virtual IP addresses under the downlink IP interface, generating and transmitting a DHCP discover message comprising the auto gateway configuration and the VRRP configuration to the DHCP server.

7. A method according to claim 6, further comprising receiving a DHCP offer message comprising an available IP address from the DHCP server, transmitting a DHCP request for the IP address to the DHCP server, receiving a DHCP acknowledgment from the DHCP server, adding IP address of gateway to gateway settings and notifying security applications within the gateway of the gateway information with regards to the received IP addresses.

8. A method performed by a Dynamic Host Configuration Protocol, DHCP, server for providing IP addresses to a moveable gateway, wherein the gateway is connected to a communication network via a first access point and wherein the gateway is further connectable to a plurality of hosts, which hosts may be connected to the communication network by means of the gateway, the method comprising:
receiving a request for an IP address of an uplink IP interface of the gateway from the gateway as the gateway changes access point to the second access point,
assigning an IP address of the uplink IP interface of the gateway to the uplink IP interface of the gateway and informing the gateway of the IP address of the uplink IP interface of the gateway,
receiving, from the gateway, a request for an IP address of the gateway to be used by hosts connected to the gateway,
assigning an IP address to the gateway and informing the gateway of the IP address of the gateway by sending a DHCP acknowledgement to the gateway, and
adding the IP address of the gateway to a list of an gateway IP pool.

9. A method according to claim 8, further comprising informing applications about the information about the gateway relating to the assigned IP address.

10. A method according to claim 8, wherein receiving, from the gateway, the request for the IP address of the gateway comprises receiving a DHCP discovery message comprising auto gateway configuration information and finding available IP address based at least partly on the auto gateway configuration, sending a DHCP offer comprising available IP address to the gateway.

11. A method according to claim 10, wherein receiving, from the gateway, the request for the IP address of the gateway further comprises receiving a DHCP request from the gateway, assigning the available IP address based on the DHCP offer and informing the gateway of the IP address of the gateway by sending a DHCP acknowledgement to the gateway.

12. A method according to claim 8, wherein the received request for the IP address of the gateway to be used by hosts connected to the gateway comprises auto gateway configuration information and a Virtual Router Redundancy Protocol, VRRP, configuration, the method further comprising determining whether the a virtual Medium Access Control, MAC, address is associated with IP addresses; and if so then the method comprises finding IP addresses for the gateway based on an auto gateway option comprised in the auto gateway configuration; or if not then the method comprises finding available virtual IP addresses for the gateway based on an auto gateway option and a virtual IP number sub option comprised in the auto gateway configuration.

13. A method according to claim 12, further comprising assigning IP addresses based on the virtual MAC address and client identifier to an DHCP offer and sending the DHCP offer to the gateway, receiving a DHCP request for the virtual IP addresses from the gateway, assigning the virtual IP addresses to the gateway, informing the gateway of the IP address of the gateway by sending an acknowledgement to the gateway and adding the IP address of the gateway to a list of an gateway IP pool.

14. A moveable gateway connected to a communication network via a first access point and further connectable to a plurality of hosts, which hosts may be connected to the communication network by means of the gateway, the gateway comprising:
a changing unit adapted for changing access point from the first access point to a second access point,
a requesting unit adapted for requesting an IP address of an uplink IP interface of the gateway point from a Dynamic Host Configuration Protocol, DHCP, server,
a receiving unit adapted for receiving the IP address of the uplink IP interface of the gateway from the DHCP server, and
a notifying unit adapted for notifying security applications within the gateway of the gateway information with regards to the received IP addresses.

15. A moveable gateway according to claim 14, wherein the requesting unit further is adapted for requesting an IP address of the gateway to be used by hosts connected to the gateway from the DHCP server and wherein the receiving unit further is adapted for receiving the IP address of the gateway from the DHCP server, wherein the gateway information to be notified to the security applications within the gateway further comprises the IP address of the gateway.

16. A moveable gateway according to claim 15, further comprising a specifying unit adapted for specifying an auto gateway configuration under a downlink IP interface.

17. A moveable gateway according to claim 16, further comprising a generating unit and a transmitting unit adapted for generating and transmitting a DHCP discover message comprising the auto gateway configuration, wherein the receiving unit further is adapted for receiving a DHCP offer message comprising an available IP address, the requesting unit is adapted for requesting the available IP address of gateway to be used by hosts connected to the gateway from the DHCP server and the receiving unit is adapted for receiving the IP address of the gateway from the DHCP server, and adding IP address of gateway to gateway settings.

18. A moveable gateway according to claim 14, wherein the requesting unit and receiving unit further are adapted for requesting and receiving an IP address for a Virtual Router Redundancy Protocol, VRRP, group from the DHCP server, wherein the gateway information to be notified to the security applications within the gateway further comprises the IP Address of the VRRP group.

19. A moveable gateway according to claim 14, wherein the gateway is a virtual gateway being part of a virtual redundant group, the gateway further comprising a specifying unit adapted for specifying an auto gateway configuration under a downlink IP interface, specifying a Virtual Router Redundancy Protocol, VRRP, configuration comprising number of virtual IP addresses under the downlink IP interface, wherein the generating unit and the transmitting unit are adapted for generating and transmitting a DHCP discover message comprising the auto gateway configuration and the VRRP configuration to the DHCP server.

20. A moveable gateway according to claim 19, wherein the receiving unit further is adapted for receiving a DHCP offer message comprising an available IP address from the DHCP server, wherein the transmitting unit further is adapted for transmitting a DHCP request for the IP address to the DHCP server, the receiving unit is adapted for receiving a DHCP acknowledgment from the DHCP server and adding IP address of gateway to gateway settings and wherein the notifying unit is adapted for notifying security applications within the gateway of the gateway information with regards to the received IP addresses.

21. A Dynamic Host Configuration Protocol, DHCP, server adapted for providing IP addresses to a moveable gateway, wherein the gateway is connected to a communication network via a first access point and wherein the gateway is further connectable to a plurality of hosts, which hosts may be connected to the communication network by means of the gateway, the DHCP server comprising:
a receiving unit adapted for receiving a request for an IP address of an the uplink IP interface of the gateway from the gateway as the gateway changes access point to the second access point,
an assigning unit adapted for assigning an IP address of the uplink IP interface of the gateway to an uplink IP interface of the gateway,
an informing unit adapted for informing the gateway of the IP address of the uplink IP interface of the gateway,
wherein the receiving unit further is adapted for receiving, from the gateway, a request for an IP address of the gateway to be used by hosts connected to the gateway, and wherein the assigning unit further is adapted for assigning an IP address to the gateway, wherein the DHCP server 600 further comprises:
an adding unit adapted for the IP address of the gateway to a list of an gateway IP pool,
wherein the informing unit further is adapted for informing the gateway of the IP address of the gateway.

22. A DHCP server according to claim 21, wherein the informing unit further is adapted for informing applications about the information about the gateway relating to the assigned IP address.

23. A DHCP server according to claim 21, wherein the receiving unit further is adapted for receiving, from the gateway, the request for the IP address of the gateway by receiving a DHCP discovery message comprising auto gateway configuration information and finding available IP address based at least partly on the auto gateway configuration, the DHCP server further comprising a transmitting unit adapted for sending a DHCP offer comprising available IP address to the gateway.

24. A DHCP server according to claim 23, wherein the receiving unit is adapted for receiving, from the gateway, the request for the IP address of the gateway by receiving a DHCP request from the gateway, the DHCP server further comprising a an allocating unit adapted for allocating the available IP address based on the DHCP offer and sending a DHCP acknowledgement to the gateway.

25. A DHCP server according to claim 21, wherein the received request for the IP address of the gateway to be used by hosts connected to the gateway comprises auto gateway configuration information and a Virtual Router Redundancy Protocol, VRRP, configuration, the DHCP server further comprising a determining unit adapted for determining whether the a virtual Medium Access Control, MAC, address is associated with an IP address; and if so then the DHCP server comprises a finding unit adapted for finding IP addresses for the gateway based on an auto gateway option comprised in the auto gateway configuration; or if not then the finding unit is adapted for finding available virtual IP addresses for the gateway based on an auto gateway option and a virtual IP number sub option comprised in the auto gateway configuration.

26. A DHCP server according to claim 25, wherein the assigning unit further is adapted for assigning a virtual IP address based on the virtual MAC address and client identifier to an DHCP offer, wherein the transmitting unit is adapted for sending the DHCP offer to the gateway, the receiving unit is adapted for receiving a DHCP request for virtual IP addresses from the gateway, the allocating unit adapted for allocating virtual IP addresses to the gateway, and the transmitting unit is adapted for sending an acknowledgement to the gateway and adding the IP address of the gateway to a list of an gateway IP pool.

27. A Computer program, comprising computer readable code means, which when run in a processing unit comprised in an arrangement in a gateway causes the gateway to perform the corresponding method according to claim 1.

28. A Computer program product comprising computer program according to claim 27.

29. A Computer program, comprising computer readable code means, which when run in a processing unit comprised in an arrangement in a Dynamic Host Configuration Protocol, DHCP, server causes the DHCP server to perform the corresponding method according to claim 8.

30. A Computer program product comprising computer program according to claim 29.
